(19) United States
(12) Patent Application Publication
(10) Pub. No.: US 2011/0029890 A1
(43) Pub. Date: Feb. 3, 2011

(54) ONLINE FUNDRAISING

(75) Inventor: Olivia Cosgrove, Co. Fermanagh (GB)

Correspondence Address: KNOBBE MARTENS OLSON & BEAR LLP, 2040 MAIN STREET, FOURTEENTH FLOOR, IRVINE, CA, 92614, US

(73) Assignee: Donor2Deed Limited, Co. Fermanagh (GB)

(21) Appl. No.: 12/511,798

(22) Filed: Jul. 29, 2009

(51) Int. Cl. G06F 3/048; G06F 3/01; G06Q 20/00; G06Q 40/00; G06Q 10/00

(52) U.S. Cl. 715/751; 715/835; 715/772; 705/39; 705/30

(57) ABSTRACT

A method of facilitating fundraising uses a computer network. The method outputs from a computer server, data identifying projects for which a user can make a donation. The data is presented using a map-based graphical user interface with a project identified on a map of a geographical area. At the server, a user selection of at least one of the projects is received via the map-based graphical user interface. Projects of a plurality of organizations can be represented on the same map-based graphical user interface. Progress information is collected at the server and reported to donors. Donations and progress information can be output to social networking or micro-blogging sites.

### BACKGROUND OF THE INVENTION

1. Field of the Invention

The present invention relates to fundraising over a communications network.

2. Description of the Related Art

Non-profit organizations (NPOs), fundraising organizations, charitable organizations and Non-Government Organizations (NGOs), typically raise funds by advertising campaigns using media such as newspapers, magazines, television and websites. It is also known to solicit donations by directly mailing or calling potential donors, but this is often viewed as undesirable by the public. It is further known to make street collections and organize events which donors can sponsor.

More recently, websites such as “JustGiving™” (www.simplygiving.com) and “Firstgiving™” (www.firstgiving.com) act as a portal for multiple organizations. A donor can select from a number of organizations registered with the website and make an online donation. A user of these websites is required to know, in advance, a name of an organization which has registered with the site.

### SUMMARY OF THE INVENTION

Methods of facilitating fundraising using a computer network are described. An embodiment comprises outputting, from a computer server, data identifying projects for which a user can make a donation, the data being presented using a map-based graphical user interface with a project identified on a map of a geographical area; and receiving, at the server, a user selection of at least one of the projects via the map-based graphical user interface.

Another embodiment comprises outputting, from a computer server, data identifying projects for which a user can make a donation; receiving, at the server, a donation from a user for a selected one of the projects and storing details of the user; receiving, at the server, progress information about progress of the selected project; and outputting the progress information to the user who made the donation using the stored details.

A method of reporting financial data using a computer network comprises storing, at a computer server, data for a plurality of projects, the project data including an identifier of the geographical location of the project and a first field representing a financial quantity associated with the project; providing a map-based graphical user interface with the location of the projects identified on a map of a geographical area; receiving financial update data; updating the first field with the received financial update data; and presenting the first field via the map-based graphical user interface.

### BRIEF DESCRIPTION OF THE DRAWINGS

Embodiments of the invention will be described, by way of example only, with reference to the accompanying drawings in which:

FIG. 1 shows a system for fundraising over a communications network;

FIG. 2 shows functional units of the system of FIG. 1;

FIG. 3 shows a database used in the system of FIGS. 1 and 2;

FIG. 4 shows a flow chart of a homepage of a web application forming part of the system;

FIG. 5 shows an example homepage layout;

FIG. 6 shows a user account log-in page;

FIG. 7 shows a flow chart for accessing user account preferences;

FIG. 8 shows a flow chart of operating the map-based graphical user-interface;

FIGS. 9 and 10 show example screen shots during the map-based graphical user-interface;

FIG. 11 shows a flow chart of options for an NPO homepage;

FIG. 12 shows a flow chart of options for news pages;

FIGS. 13 to 15 shows example screen shots for displaying project details;

FIG. 16 shows a flow chart of steps for making a donation;

FIGS. 17 to 20 show example screen shots for the process of making a donation;

FIG. 21 shows a method of reporting project progress information to a donor;

FIG. 22 shows use of an external source of map data;

FIGS. 23 to 26 show example screen shots of an application for a social networking site;

FIG. 27 shows example screen shots of an application for a social networking/micro-blogging site;

FIG. 28 shows a method of reporting financial data using a map-based GUI.

### DETAILED DESCRIPTION OF THE INVENTION

The words “comprises/comprising” and the words “having/including” when used herein with reference to the present invention are used to specify the presence of stated features, integers, steps or components but does not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

In this specification the term “Non-Profit organization (NPO)” is intended to include any organization that does not make a profit, including public organizations such as universities, schools etc. and includes fundraising organizations, charitable organizations and Non-Government Organizations (NGO).

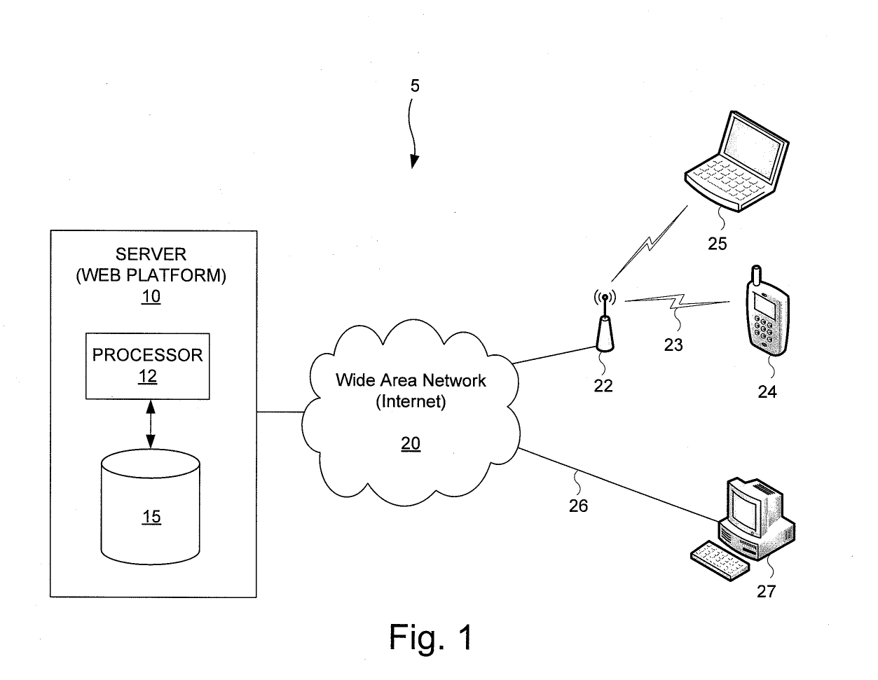

FIG. 1 shows a system 5 for performing online fundraising. A server or web platform 10 comprises one or more processors 12 and storage 15. A communications network 20, such as a wide area communications network (e.g. the Internet), connects the web server 10 to client devices 24, 25, 27. Client devices connect to the wide area network 20 via a wireless access network 22, 23, a wired access network 26 or a combination of wired and wireless access networks. Client devices 24, 25, 27 can include mobile telephones, smart phones, Personal Digital Assistants (PDA), mobile computers (e.g. laptops or netbooks), desktop computers and any kind of communication device. System 5 will, in practice, have a much larger number of client devices 24, 25, 27 than those shown in FIG. 1.

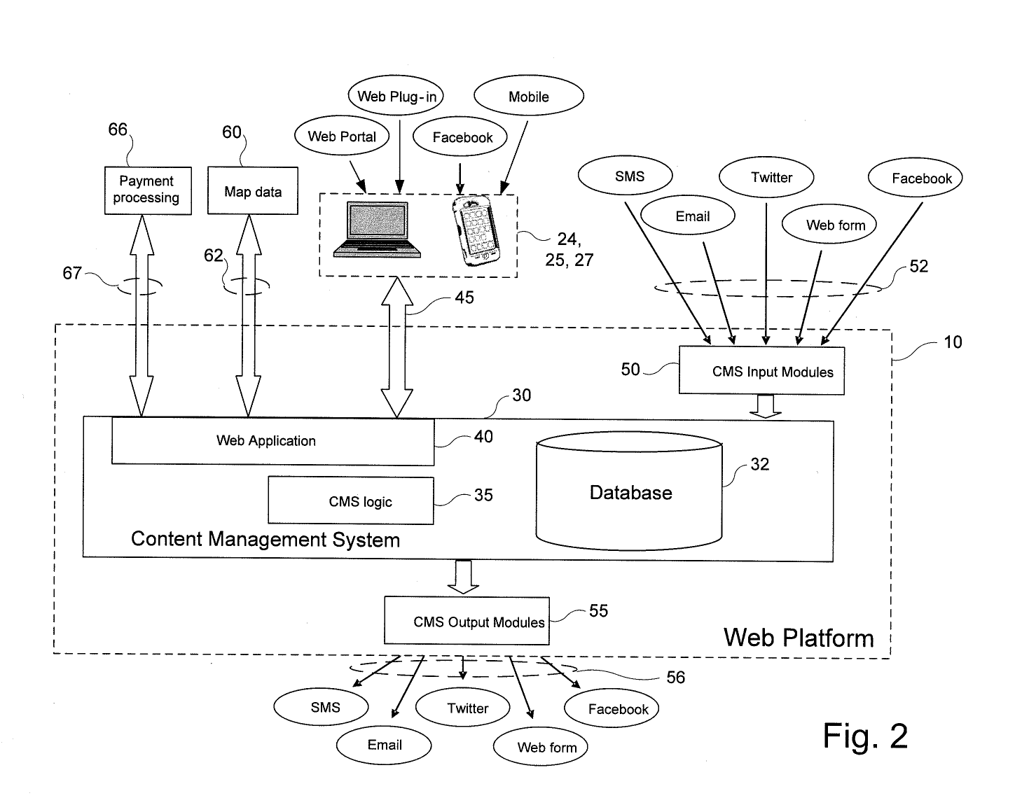

FIG. 2 shows functionality provided at the server 10 of FIG. 1. A Content Management System 30 includes a database 32 which stores data relating to Non-Profit organizations (NPOs) and registered users. The database 32 stores multimedia content which can include text, images, video and audio content. The database 32 can be a Structured Query Language (SQL) database. Advantageously, the database 32 is stored on storage 15 shown in FIG. 1. Alternatively, database 32 can be stored in a different physical location to the rest of the CMS 30, or can be distributed across multiple storage devices at different locations.

CMS Input Modules 50 interface with a range of different input feeds 52. A non-exhaustive list of input feeds includes: text messages (e.g. Short Message Service (SMS) messages), multimedia messages (e.g. Multimedia Message Service (MMS) messages), email messages, web forms, social networking or micro-blogging feeds (e.g. Facebook™, Twitter™, Bebo™). As will be explained, the input feeds 52 contribute content which is stored in the database 32. The content contributed via the input feeds 52 can originate from members of NPOs and can give information about new projects to which users can donate, or news information which describes the progress of existing projects.

CMS Output Modules 55 provide a range of different output feeds 56. The output feeds can be of the same type as those supported by the input modules 50, or the CMS Output Modules 55 can support a wider or narrower range of feed types. CMS Output Modules 55 receive content from the database 32 along with data indicating the intended recipient of the output feed. One purpose of the output feeds 56 is to distribute news information which updates donors about the progress of a project to which they have donated. A donor can register with the CMS 30 with preferences of which type of information they wish to receive, and the contact method (email, text message, multimedia message, social networking update etc.

The Content Management System 30 includes logic 35 which controls the storage of content in the database 32. Logic 35 also controls access to, and distribution of, content stored in the database. A web application 40 interfaces 45 bi-directionally with client devices 24, 25, 27. Client devices 24, 25, 27 each run browser software. The web application 40 constructs web pages for delivery to client devices 24, 25, 27 using content stored in the database 32 and based on inputs received from the client devices 24, 25, 27. One feature of the web pages is a map-based graphical user interface (GUI) which identifies the geographical location of projects and allows a user to select a project identified on the map. The map-based GUI also allows a user to zoom further into a particular geographical area to see that area, and projects in that area, in more detail. There are several options for providing the map data for the map-based interface. An advantageous scheme is shown in FIG. 2, where an external source of map data 60 is used, such as Google Maps™. The web application 40 communicates with the provider of the external map data 60 via an Application Programming Interface 62. An alternative option is for the map data to be stored locally at the content management system 30.

Advantageously, functional modules 35, 40, 50, 55 shown in FIG. 2 are implemented as software which is stored in storage 15 (FIG. 1) and executed by a processor 12 (FIG. 1), or multiple processors.

The CMS 30/web application 40 communicates with a payment processing entity 66, such as a credit card clearing center or bank, via an interface 67.

Client devices which do not support Internet browsing can also be supported by the use of a suitable interface at the server 10 or at an intermediate node in networks 20, 22, 26. The interface will allow a map-based GUI with overlaid project information to be sent to a client device, and will allow a more limited set of controls at the client device to be used for responses, such as a set of interactive buttons on a remote control. Interactive digital TV terminals are an example of this more restricted client device.

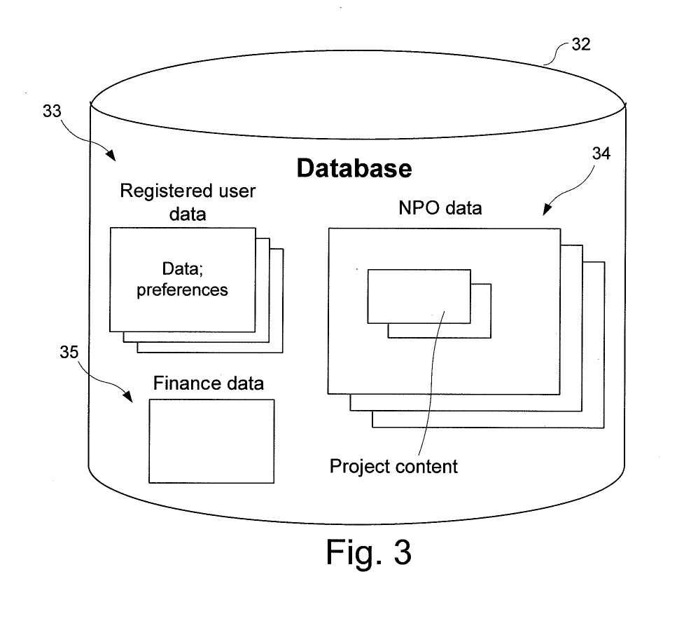

FIG. 3 shows the database 32 in more detail. Three main types of data are stored: data 33 about registered users; data 34 describing NPOs and the project(s) of NPOs; and finance data 35 about donations, which can include total donations per NPO, per NPO project, per donor and data about the total amounts each NPO wishes to raise. Registered user data 33 includes details such as username and log-on password, contact details and preferences for the user, such as the type of data they wish to receive and the type of delivery mechanism by which they wish to receive data (email, text message, multimedia, message, social network update etc.) Registered users include donors, i.e. persons making donations, as well as members of NPOs who access the site to update content. NPO data 34 includes project content.

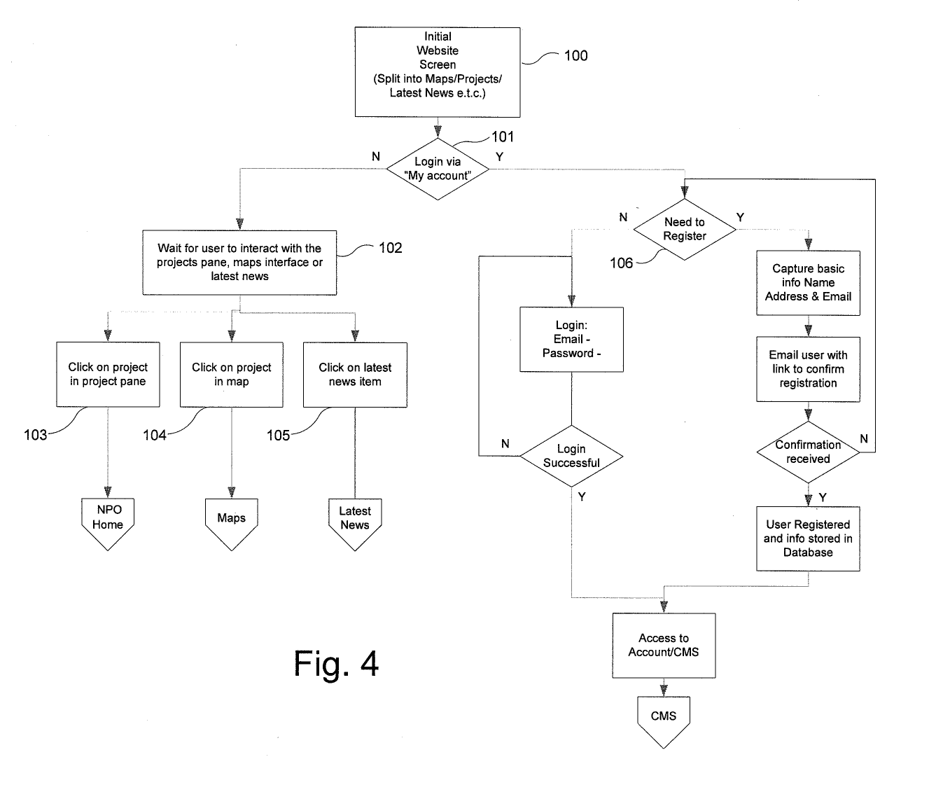

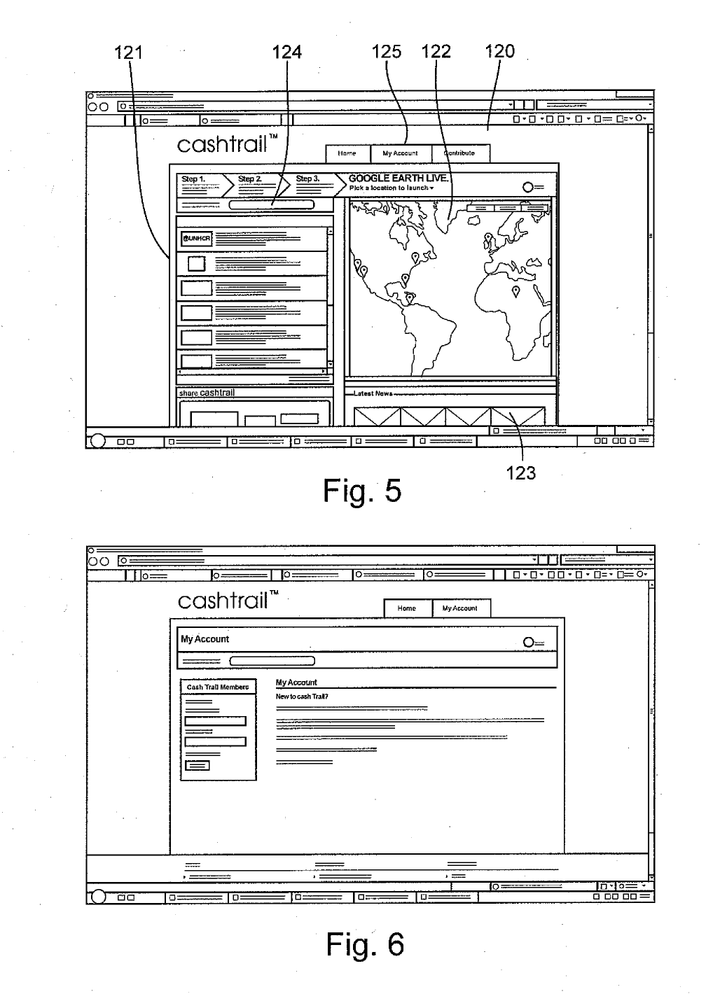

The web application 40/CMS 30 will now be described. FIG. 4 shows a flow chart describing the initial website screen of the web application 40. At step 100 the initial website screen, or “home page” 120, is presented. An example home page is shown in FIG. 5. The main sections of the home page 120 are a projects frame 121, a map frame 122 and a news frame 123. At step 101 a user can proceed to a log-in page by clicking on “My account” tab 125. Otherwise, web application 40 waits at step 102 for a user to interact with one of the main frames 121-123 presented on the home page 120. Each of the frames 121-123 are now described.

### Projects Frame

The projects frame 121 is shown on the left of the screen shot. Information on each NPO who is subscribing to the Donor2Deed website will be displayed in this section. The Projects frame 121 shows a list of various NPOs with their profile project (which will have NPO logo, target amount and amount raised). This information is stored in the NPO table in the database 32 and will be supplied by the website operator (e.g. Donor2Deed) and/or the NPO. Clicking on one of these will bring the user to the NPO homepage with the project ‘In Profile’. Other projects will be listed below these. The ‘In Profile’ project will have a donate and ‘click to see more’ button as well as target and amount raised. If a user clicks on any of the other projects below this, the rest will slide up and this project will be shown in the same size box as the ‘In Profile’ one, with the same buttons and information but without the In Profile heading.

This listing of the NPOs in the projects frame 121 is determined by the CMS 30. The CMS 30 can use various rules to determine the order in which projects and NPOs are listed in the projects frame 121, such as: a time-shared based (e.g. offering each NPO an equal share of being first in the list); a first-in basis and so on.

When the user clicks on a particular NPO logo or heading text the screen will refresh and the user will be brought to the projects page for that NPO where only projects for that NPO will be displayed. This will look similar to the screen above except only project information for the NPO will be displayed and the map frame refreshes to only display projects related to this NPO.

### Map

The initial map shown in frame 122 can be configured to display all projects associated with all of the NPOs registered with the site for a particular area. The map that is initially displayed in frame 122 can alternate on a time basis (e.g. every hour) between showing an “America/Europe/Africa” view to an “Asia” view, or cycle through a larger number of more specific geographical areas, e.g. America, Europe, Africa, Asia, Australia. An advantage of displaying all projects in the initial map is that it allows a democratic representation of all of the organizations registered with the site, i.e. all organizations appear on the map with equal status.

### Project Search

The projects frame 121 can also include a search bar 124 which allows a text-based search where all words that are entered will be used to search the project database and return all projects that match the criteria. The project location, theme, heading and description can be searched using the keywords entered. The map 122 and the Latest News section 123 can be configured such that, when a search is performed, they only show information relating to those projects that have been returned in the search.

### Latest News

This frame 123 shows, for each project, the latest update added to the database 32 for that project. This can include an image and text describing the update and a video clip. Clicking on the any of the latest news on the front page will zoom the map 122 into that project and bring up the latest news tab.

### Share Donor2Deed

This section will list various partner websites to be determined by Donor2Deed that will allow users to share the website with their accounts on other websites.

Returning to step 101 of FIG. 4, a user clicks on the “My Account” tab to reach a log-in screen. An example screen shot is shown in FIG. 6. If the user has already registered with Donor2Deed then the user can input their Email address (which will be used to identify them within the system) and their password. If a valid address is entered the user will be returned to the initial screen and a welcome message with their name will be displayed on the screen. However, if the user is not found they will be asked if they wish to register with the website. Advantageously, a user is required to register with the website in order to complete a donation. The user can register from this page or they can choose to register when making a donation. The following information can be collected at user registration: User Id, User Password, Email address, Name, User Location (country), Address, Telephone number, Date record created. Some of these fields can be optional.

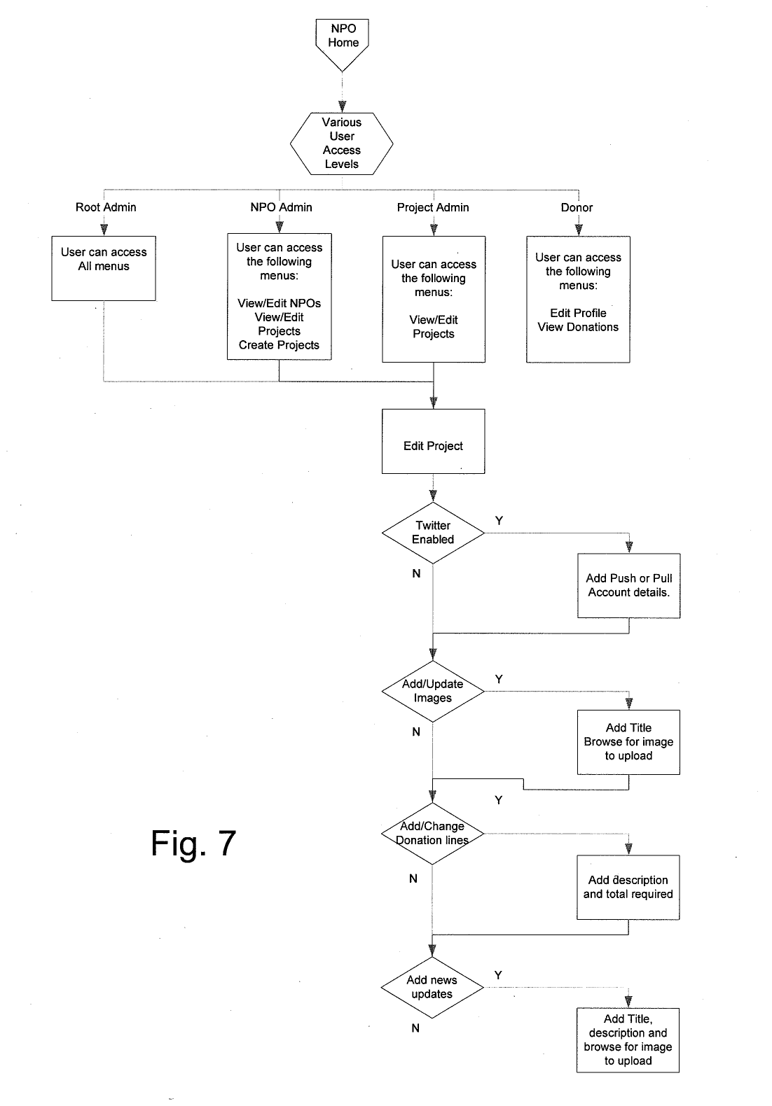

FIG. 7 shows options upon successfully logging into a user account. The options available to a user depend on the type of user, namely: root admin, i.e. administrator of the website; NPO Admin, i.e. administrator of an NPO registered with the website; Project Admin, i.e. a person working on behalf of a project owned by a NPO; donor, i.e. any person who has donated to a project, or wishes to make a donation. FIG. 7 shows some example options for the feature of editing project information and settings to a project.

For each of the main database tables: NPOs, Projects and Users, there is an online form which allows the information to be maintained. The forms match the table structures of the relevant data structures held in database 32 so each field on the database table will have a corresponding form field.

### Map-Based User Interface

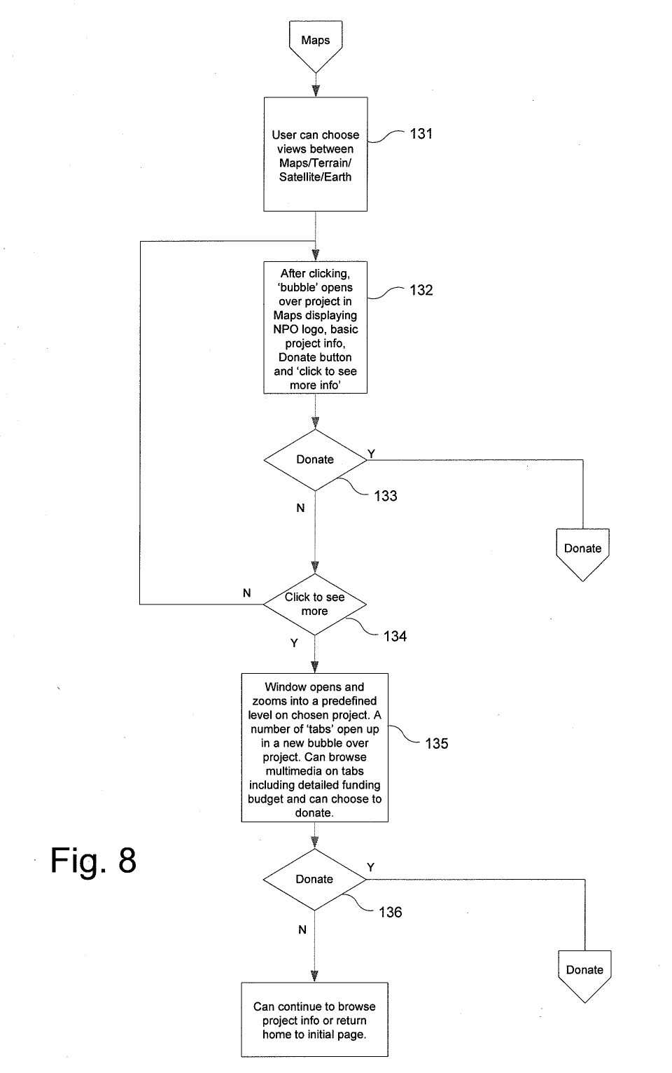

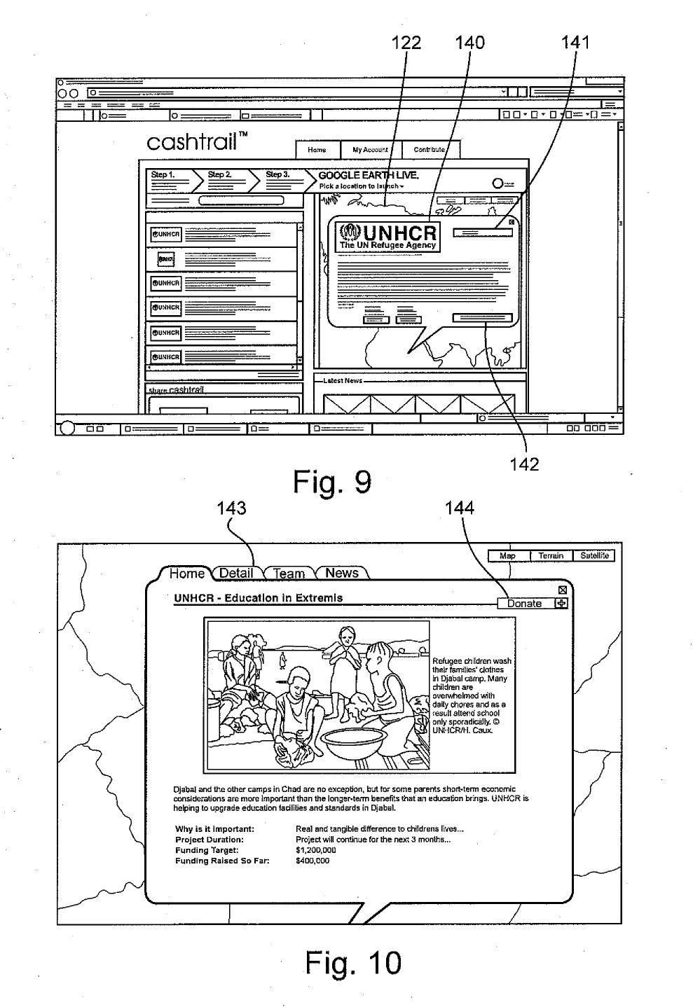

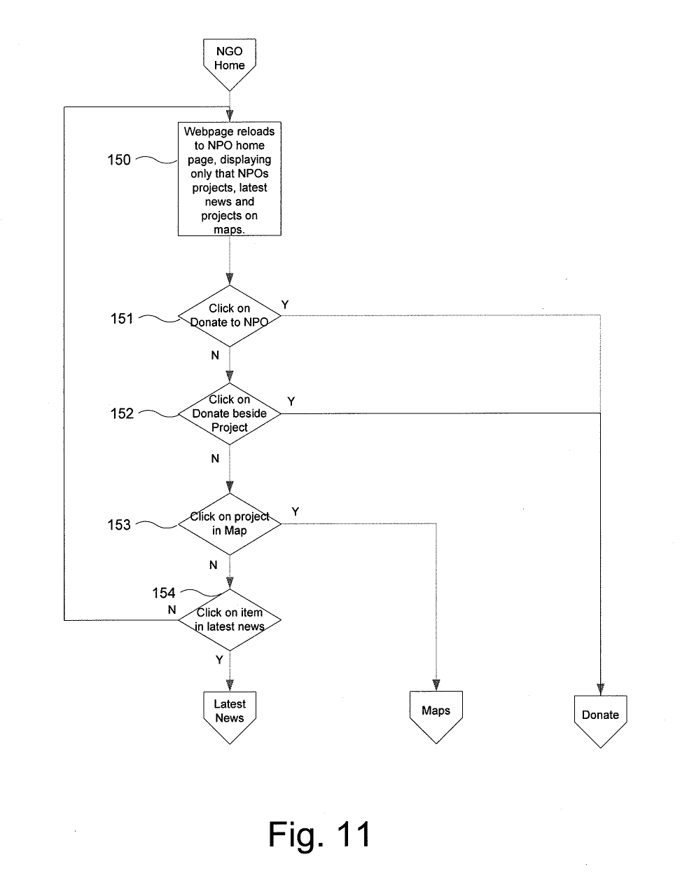

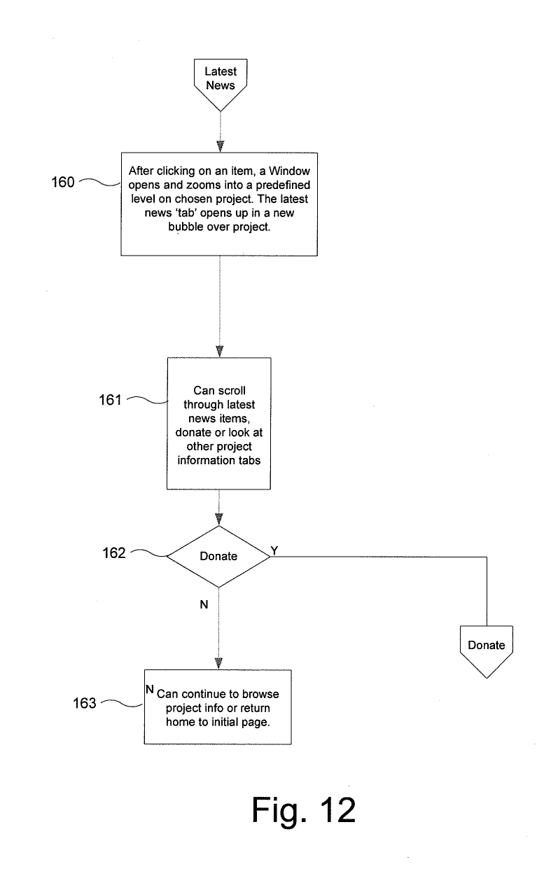

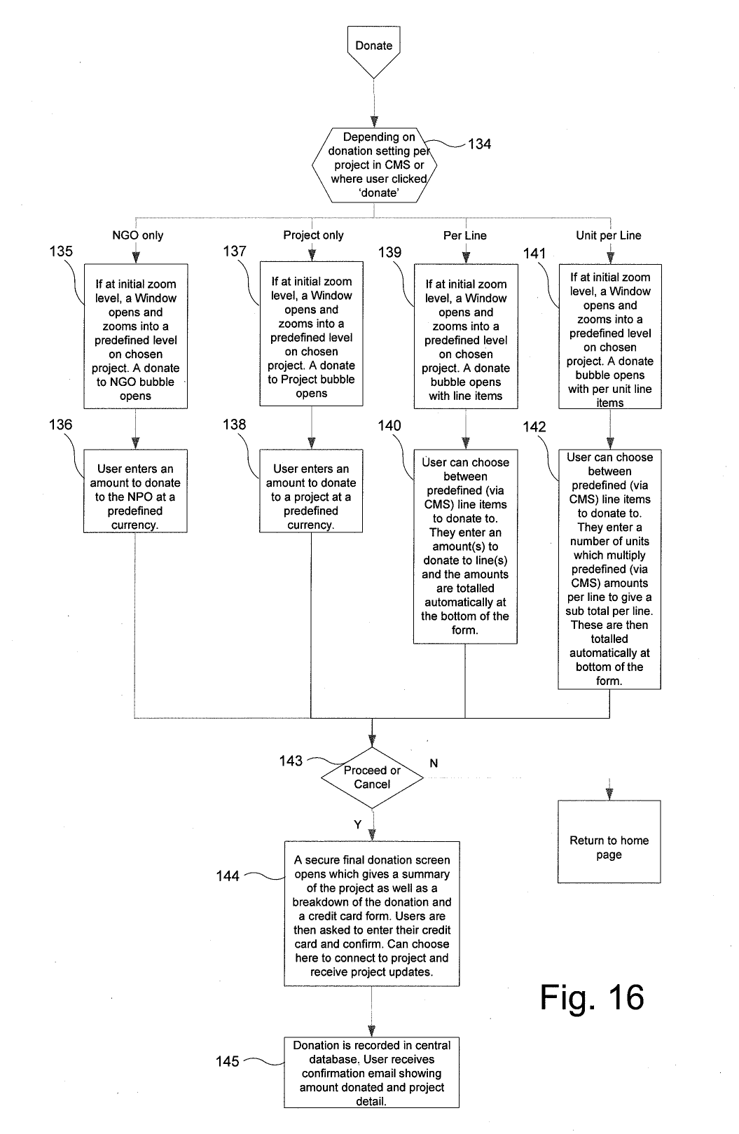

FIG. 8 shows method steps associated with the maps frame 122 of the home page 120. At step 131 a user can select different map formats: map, which shows places, roads and other features; terrain, which shows relief, water features, land type (desert etc.); satellite, which shows an aerial view; and earth, which begins with a global view of the world. The displayed map is overlaid with flags indicating the location of projects. When a user clicks on a flag representing a project this causes a small window 140, or “bubble”, to open in the frame 122 giving more information about the selected project. FIG. 9 shows an example screen shot at this stage. The window 140 has a button 141 which gives the option of making a donation to the project. If a user clicks on the donate button at step 133, the method proceeds to the donate method detailed in FIG. 16. Window 140 also has a link or button 142 giving the option of allowing a user to find out more about the project. When a user selects this button at step 134 the method proceeds to step 135 to display a larger scale map shows the location of the project in more detail. The map can be displayed in a new, larger, frame than that used in the home page. The frame displays more detail of the project, with tabs 143 giving access to further pages with still further detailed information, team information and news. An example screen shot is shown in FIG. 10. The additional pages of information accessed via tabs 143. Again, a user is given the option of donating via a button 144 and, if a user clicks on the donate button at step 136, the method proceeds to the donate method detailed in FIG. 14. The map-based interface can follow these rules:
The map view initially presented on the homepage can alternate on a time basis (e.g. every hour) between showing an “America/Europe” view and an “Asia” view.
On the initial screen all projects within the current geographical area covered by the map are shown.
When an NPO is selected, only projects for that project are displayed.
The map refreshes to show those projects that are selected by the user or returned by a project search.
   If the website holds details of a large number of projects within the same geographical area then it may not be possible to individually show every project by a separate flag. The map-based interface can decide how to best display project data. One option is to display one flag per country will a user can then select to zoom in to a higher level of detail to show all projects. More generally, multiple zoom levels can be used depending on the amount of data to display.

### NPO Homepage

Returning to FIG. 4, one of the options at the homepage 120 is to select one of the projects located in the project frame 121. Clicking on one of the project titles or images presented in project frame 121 will bring the user to an NPO homepage. The NPO homepage has the same basic layout as that of the overall homepage shown in FIG. 5, with a project frame 121, map frame 122 and news frame 123. This helps a user navigate around the site more easily. FIG. 14 shows options from the NPO homepage. Firstly, the NPO homepage opens at step 150 with the project that was selected on the project pane 121 presented first. Other projects of that NPO will be listed below the selected project. No other NPOs are displayed. The map pane 122 refreshes to only display projects related to the selected NPO. If the NPO has several projects in one area these can be presented using a spider graph, with lines linking the geographical location of a project on the map to information about that project.

The featured project will have a link or button giving the option to donate (step 152) and a link or button which gives the user the option to see more detail. Fields display a donation target and an amount currently raised. If a user clicks on any of the other projects below the featured project, the remaining projects will slide up and this project will be shown in the same size box as the featured one, with the same buttons and info but without the “In Profile” heading. Other options from the NPO homepage are: make a donation to the NPO (step 151); select a project in the map pane 121 (step 153); and to select a news item in the news pane 123 (step 154).

### News Page

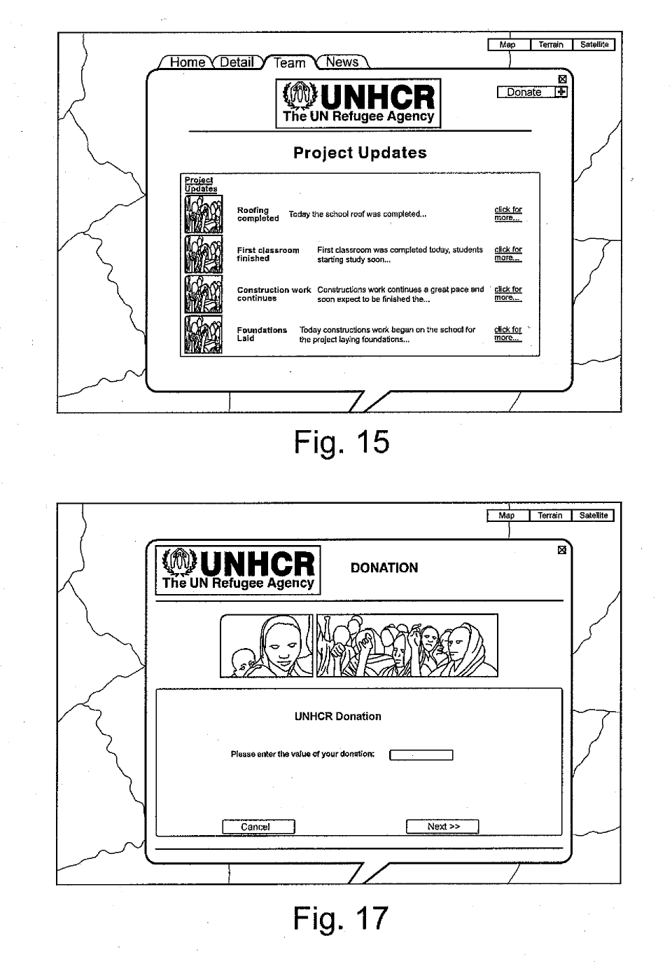

Returning to FIG. 4, another of the options at the homepage 120 is to select one of the news items located in the news frame 123. Clicking on a news item causes a window to open and zoom into a predefined level on the project to which the news item relates. The latest news ‘tab’ opens up in a new bubble over the project. FIG. 15 shows options from this stage. A user can select another news story at step 161 or can make a donation at step 162 to one of the projects featured in a news item. Alternatively, a user can view other news items or return to the homepage 120 at step 163.

### NPO Information

The following section describes the types of information that are stored as part of the NPO data 34 in database 32.

Table Name: NPOS
The main NPO table will contain the following information:

| Field Name | Field Description | Size |
|---|---|---|
| NPOId | Unique ID used in the database used to identify the | 6 |
| | individual NPO. This number will always be unique | |
| | and will auto increment as each new NPO is added to | |
| | the system. | |
| Name | NPO Name. This information will be used when | 100 |
| | displaying the NPO information in the initial screen. | |
| Profile | Main text used when displaying the NPO information | 200 |
| Information | in the Charity Profile Information section of the NPO | |
| Main | page. | |
| Profile | Sub text used when displaying the NPO information in | 200 |
| Information | the Charity Profile Information section of the NPO | |
| Sub | page. | |
| Contact Name | Name of the main contact person for the NPO | 40 |
| Email | Main contact email for the NPO | 100 |
| Website | Website address for the NPO | 100 |
| PhoneNo | Main Phone Number for the NPO | 30 |
| DateAdded | Date the NPO record was populated. | |
| ActiveYn | Indicates if the record is still active. Only active | |
| | records are displayed. | |
| LayeredDonation | This field if clear means that all donations will go | |
| | directly to the NPO. If set then per project donating is | |
| | enabled. | |
| Currency | Currency of donation. Will normally be Dollar, Euro or | |
| | Pound Sterling in Phase I | |

A number of images are associated with each NPO. These include:

Logo.gif—Image used when the NPO is displayed in the initial screen in the projects section.

Profile.gif—Image used when displaying the NPO specific page.

### Project Information

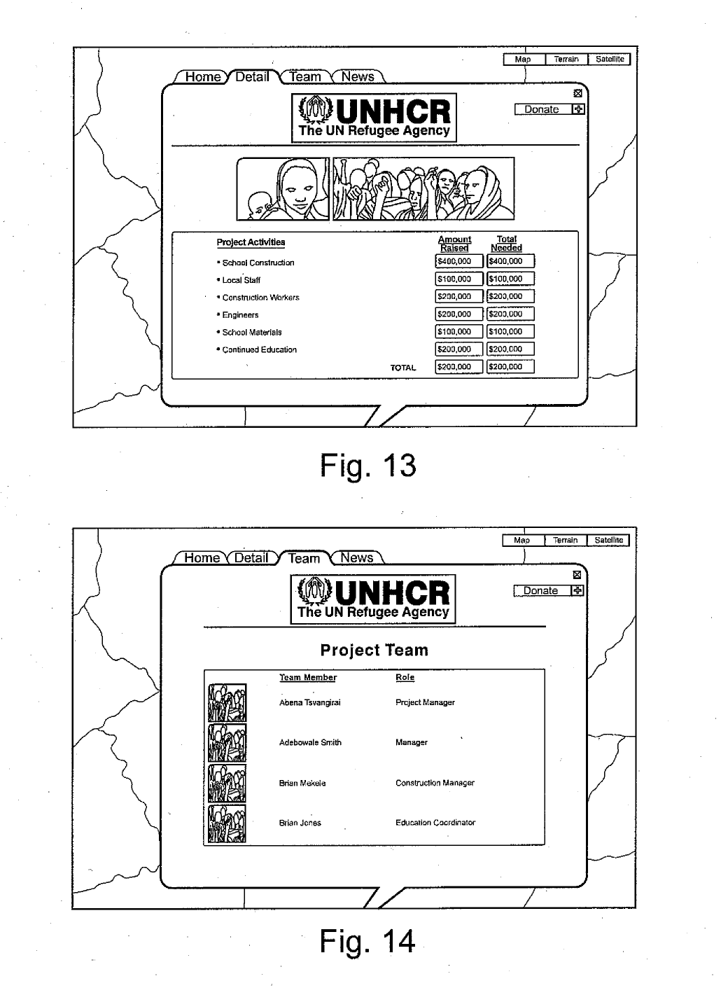

FIG. 10 and FIGS. 13 to 15 show information about each project, arranged as a set of tabbed pages. All projects will have, at a minimum, a Home Tab shown in FIG. 10. The additional tabs of FIGS. 13 to 15 are displayed only if the additional information has been provided for that project. Advantageously, database 32 should hold the following information for each project:

at least one image (e.g. project logo, project photo);

a description of the project;

description of why the project is important;

the expected project duration;

the funding target of the project;

the funding/donation value that has been raised so far.

FIG. 14 shows an example screen shot of the Team tab. This tab will be only displayed if the project team information has been populated. A Donate button will also be present which will lead to the project stage of the donate process.

FIG. 15 shows an example screen shot of the News/Updates tab. Each update contains a title and description and advantageously also includes at least one image. A Donate button will also be present which will lead to the project stage of the donate process.

### Project Database Tables

### Project Information

The main Project database table will contain the following information:

Table Name: Projects

| Field Name | Field Description | Size |
|---|---|---|
| ProjectId | Unique ID used in the database used to identify the individual | 6 |
| | Project. This number will always be unique and will auto | |
| | increment as each new Project is added to the system. | |
| NPOId | ID that links this project to a specific NPO. This will be the | 6 |
| | unique ID number on the NPO table | |
| Title | The main summary information on the project. | 70 |
| Description | Extended content detailing more information about the | 500 |
| | project. | |
| Duration | Text indicating the expected length of the project. | 100 |
| Why Important | Text detailing why this project is important. | 200 |
| Location | Coordinates of the project. This can be expressed as latitude | |
| | and longitude or using any other suitable addressing scheme. | |
| | ZIP codes (postal codes) can be used to identify location for | |
| | projects in countries which use this type of addressing | |
| | scheme. | |
| Country | Selected from a drop down list of countries. | 50 |
| ParentId | Project ID of the parent project of this project. This is so this | 6 |
| | project can be linked to a larger project. | |
| Priority | Flag to indicate if the project is a priority project. | 1 |
| Total Cost | Total cost of completing the project | |
| Donated So Far | Total value of donations made to this project. | |
| Currency | Determines what currency the project values are displayed in. | |
| DateAdded | Date the project record was added | |
| DateUpdated | Date updates are made to the record. | |
| ActiveYn | Indicates if the record is still active and will be displayed. | |
| LayeredDonation | This field if clear means that all donations will go directly to | |
| | the NPO. If set then per project donating is enabled for this | |
| | project. | |
| DonationPerLine | This field is set if the NPO requires the detailed donation | |
| | screen to be a per line units selection rather than a straight | |
| | amount entered per line. | |

### Project Images

Image information for the project will be stored in a separate directory related to the project ID i.e. Image information of the Project id 1 will be stored in the project images folder in folder 1, Project ID 2 in folder 2 and so on.

Each directory will contain 3 main images used in displaying the project:

ProjectSmall.jpg—Project Image that will be used when displaying the project in the scrollable area under projects.

ProjectMedium.jpg—Project Image that will be used when displaying the project in the Profile area of the scrollable area.

ProjectLarge.jpg—Project Image that will be used when the displaying the project in the “more info” page.

Table Name: ProjectSection

| Field Name | Field Description | Size |
|---|---|---|
| ProjectId | Unique ID used in the database used to identify the individual | 6 |
| | Project. This will allow the Section record to be linked to the | |
| | specific project. | |
| SectionId | Unique ID used to identify the project section. This number will | 4 |
| | be unique and will auto increment as each new section is added | |
| | to the project. | |
| Description | Description detailing this element of the project more | 200 |
| | information about the project. | |
| Cost | Numeric value detailing the expected cost of completing this | |
| | section of the project. | |
| Donated So Far | Total value of donations made to this section of the project. | |
| DateAdded | Date the section record was added | |
| ActiveYn | Indicates if the record is still active and will be displayed. | |

Table Name: ProjectTeams

| Field Name | Field Description | Size |
|---|---|---|
| ProjectId | Unique ID used to identify the project. This will allow the Team | 6 |
| | record to be linked to the specific project. | |
| MemberId | Unique ID used in the database used to identify the individual | 4 |
| | Project Team Member. This number will always be unique and | |
| | will auto increment as each new Project is added to the system. | |
| First Name | First Name of the team member | 50 |
| Last Name | Last Name of the team member | 50 |
| Role | Description of this team member's role in the project. This will | 100 |
| | be free text entry but can be a pre-defined list of options if | |
| | required. | |
| Hierarchy | Hierarchy of this team member. This will determine the order in | |
| | which the Team Member is displayed in the team member page. | |
| DateAdded | Date the team record was added | |
| ActiveYn | Indicates if the record is still active and will be displayed. | |

### Team Images

Each team member can have a single image linked to their record. These images will be stored in a team folder under the project directory.

Table Name: ProjectUpdates

| Field Name | Field Description | Size |
|---|---|---|
| ProjectId | Unique ID used in the database used to identify the individual | 6 |
| | Project. This will allow the Update record to be linked to the | |
| | Project table. | |
| UpdateId | Unique ID used to identify this project update. This number will | 6 |
| | be unique and will auto increment as each new section is added | |
| | to the project. | |
| Title | Title summarizing the update | 30 |
| Description | Description detailing the latest update to the project. | 100 |
| DateAdded | Date of update. | |
| MediaFile | Name of the file associated with the update. This is to allow | |
| | different media types to be associated with an update, i.e. | |
| | images, video, spreadsheet, etc | |
| UpdateDate | Date update was added to the system. | |

### Update Images/Media

The media file associated with the Project Update will be stored in a directory under the project folder called Updates and in a directory with the same number as the UpdateId added to the ProjectUpdate Table.

Table Name: Donations

| Field Name | Field Description | Size |
|---|---|---|
| UserId | User Id to link this donation with this donation. | 4 |
| DonationId | Unique ID used to identify this donation. This number will be | 6 |
| | unique and will auto increment as each new donations is made | |
| | is added to the project. | |
| NPOId | NPO Id used to link this donation to a specific NPO. | 6 |
| ProjectId | Project Id used in the database used to identify the individual | 6 |
| | Project. This will allow the Update record to be linked to the | |
| | Project table. | |
| SectionId | This field will be populated if the donation is made against a | 4 |
| | particular section of the project rather than the project as a | |
| | whole. | |
| DonationValue | Value of the user donation. | |
| DateAdded | Date donation record is added. | |
| DonorMappedID | This field will be used to map this donor ID to another Donor | 6 |
| | Database such as Kintera. Note may need to add separate | |
| | table which maps userID to various donorIds as an NPO may | |
| | have multiple databases to map to. | |

### Project Data Feed

An NPO administrator can input, via a feed 52, updates on amounts to be raised, snapshots of current status, etc. If the donor has donated to this project they will receive an update if they have requested updates. The delivery mechanism for the update is based on a user's stored preferences, as stored in database 32.

### Donation Processing

FIG. 16 shows method steps associated with making a donation. Donations can be made at three general levels of granularity:
1) NPO Donation, i.e. a donation to a particular NPO;
2) Project Donation, i.e. a donation to a particular project of an NPO;
3) Project Section Donation, i.e. a donation to a particular feature of a project of an NPO.
   The type of donation that a user can make can be based on the where the user has currently navigated to on the website. Following a user selection to make a donation, a determination is made at step 134 or what type of donation options to present to a user. An NPO administrator can select what type of donation option is presented to a user.

A first option 135, 136 is to donate at the level of an NPO. FIG. 17 shows an example screen shot. The user is presented with a field which allows them to enter the donation value.

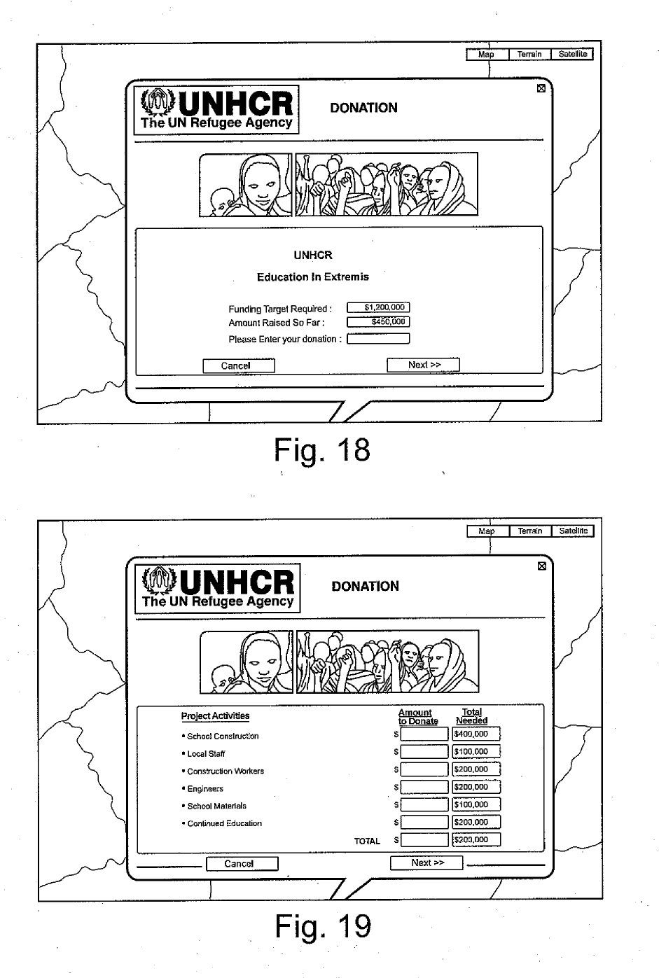

A second option 137, 138 is to donate at the level of a project, allowing a donor to make some selection as to where to target their donation. FIG. 18 shows an example screen shot. A user can arrive at this option in two possible ways:
1) On each of the project profile section of the NPO page there will a donate button.
2) On project information tabs (home, team, news) a donate button will be displayed which will bring the user to the donation wizard.
   The first page of the donation wizard displays the remaining funding target required for this project and a field which allows the user to enter the donation value. Having entered the value of the donation they want to make they will then be taken through the remaining steps of the donation wizard where they are asked for their preferred method of payment and the donation is processed.

The third option 139, 140 and fourth option 141, 142 allow donations to be made at a level within a project, allowing a donor to make a more detailed selection as to where to target their donation. FIG. 19 shows an example screen shot with six possible activities within a particular project. This is a donation to a specific section of the project. This screen will only be displayed if the user clicks the donate button on the Project Detail tab. There are two options here for detailed project donations depending on how the NPO chooses to set it up. A field per project ‘DonationPerLine’ will decide which option is to be used.

Option 1—Amount Per Line

This will display a page with all the project sections and total funding raised so far, for this project section. A field will be available for each project section to allow the user to enter a donation value against whatever project section they want. An example screen shot is shown in FIG. 19.

Option 2—Per Line Units

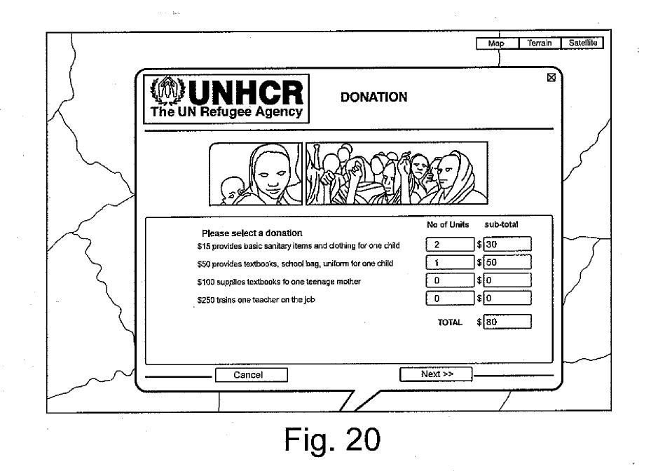

This will display a page with all the project sections, with a per line unit amount selectable to donate. An example screen shot is shown in FIG. 20.

A further possibility is to support electronic vouchers (E-Vouchers) which can be sent as links and redeemed on the platform 10. The E-vouchers can be for a particular monetary amount, which the recipient of the E-voucher can donate to a project of their choice, or can be in respect of a project or item within a project selected by the person giving the E-voucher, e.g. equipment to provide a water supply to a village, a goat for a villager.

### Donation Processing

For each of the donation options described above, the method proceeds to the remaining step 144 of the donation wizard where they are asked for their preferred method of payment and the donation is processed. This stage can include a screen which shows the following information:

Total donation

Less: 3rd party charges

Less: Donor2Deed charge

Net: Goes to project

This makes the charges transparent to the user. The totals 145 are updated to reflect the donation just made.

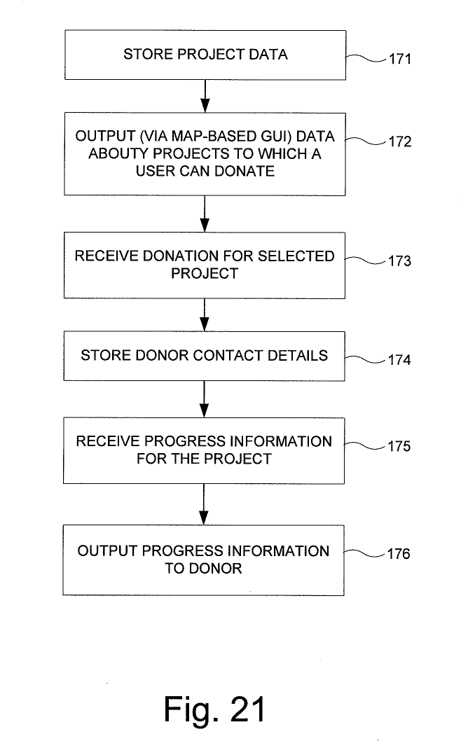

FIG. 21 summarizes the overall method of making a donation and receiving progress information. At step 171 project data is stored. The project includes geographical location of the project, where a map-based GUI is being used to present the project data. At step 172 the project data is output to a user. Advantageously, a map-based GUI is used to present the locations of the projects, as previously described. At step 173 a donation is received for a selected one of the projects displayed to a user. At step 174 donor details are stored. The user may already have entered their details by registering with the site during an earlier session. Otherwise, the system requests a user to enter contact details. At step 175, which may be some time after steps 173, 174, the system receives progress information for the project, such as information about an amount of money spent, news items about the benefits that the project has brought to the community served by the project, video clip, images etc. At step 176 the progress information is forwarded to the donor using the stored contact details. Advantageously, the user details specify a delivery mechanism for receiving the progress information. Advantageously, the user details specify a time frame of when a user wishes to receive updates e.g. monthly, weekly so they have full control over the medium and the time frame for receiving information. Progress information can be filtered based on entries in the user details (e.g. user only receives text if the user has requested to be sent progress information via text messages.)

### Interface to External Map Data

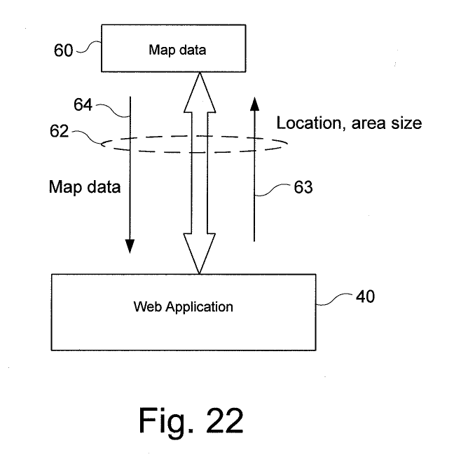

An external source of map data 60 can be used for maps presented in the map frame 122. FIG. 22 shows one scheme for accessing external map data 60 via an API 62. In the outgoing direction 63, web application 40 submits parameters which define the required map data in terms of, for example, co-ordinates and an area size or zoom level. A server hosting the map data 60 extracts map data based on the submitted parameters and sends the required data in the return direction 64 to web application. The map data is embedded within the map frame 122.

### Location-Dependent Presentation of Project Information

The initial view presented in the map frame 122 of homepage 120 can be fixed, or can be cycled through a range of start views (e.g. Europe, Africa, Asia). A further alternative is to present an initial map view which is based on the location of the user. Some client devices, such as smart phones, incorporate position-determining functionality, such as a Global Positioning System (GPS) receiver. The client device can send the determined position to web application 40. Web application 40 can then cause the map data displayed in map frame 122 to match the position of the user. A radius of the area around the current user position can be set as a system default, or can be selected by the user.

### Social Networking Application

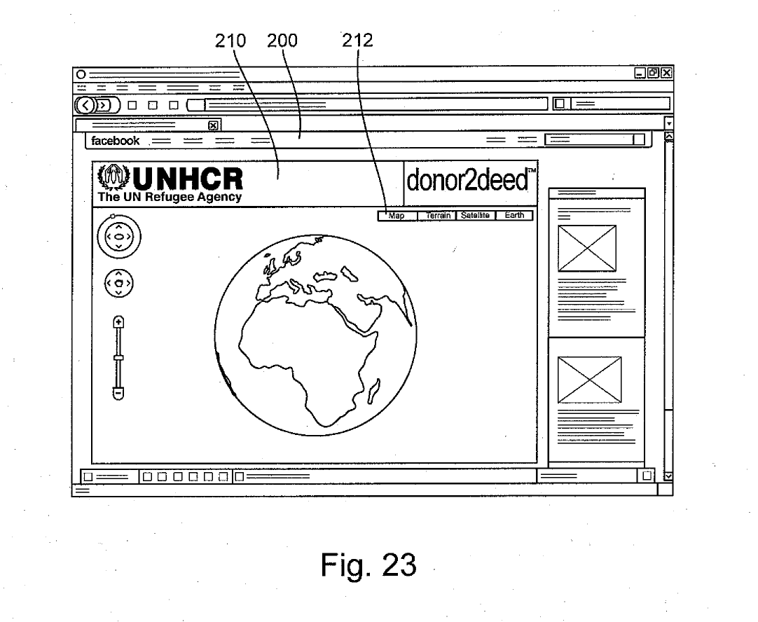

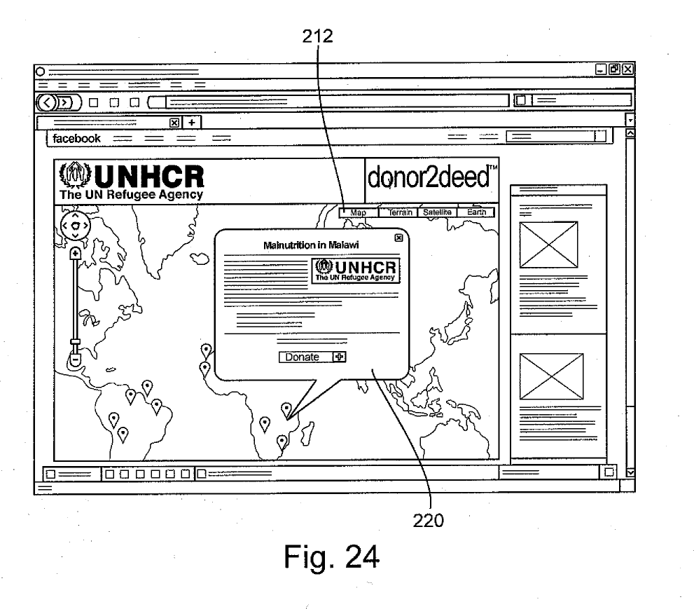

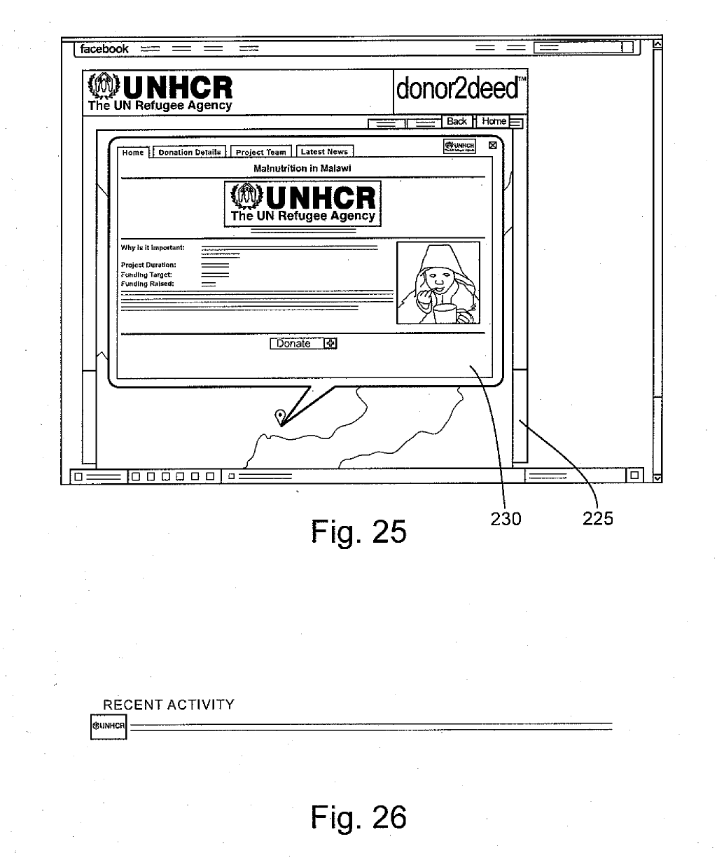

The functionality described above can be provided as a website which donors visit directly, and interact with via browser software on their client devices 24, 25, 27. The functionality can also be provided as a plug-in application which links a social networking website, such as Facebook™, to the web platform 10. Facebook™ will be used as a non-limiting example of a social networking site and the application to interface with Facebook™ will be called a Facebook Application (FBA). Social networking services allow users to join networks organized by city, workplace, school, and region and to connect and interact with other people. People can also add friends and send them messages, and update their personal profiles to notify friends about themselves. It handles multimedia updates through various applications. Facebook™ is used here as an example of a social networking site although it should be appreciated that the application can be designed for use with any other social networking site. The application allows content from the Donor2Deed website to be displayed as a frame inside a standard Facebook™ page 200, with a similar look and feel to that of the Donor2Deed website. The FBA will be available to be downloaded to a NPO's profile ‘skinned’ with their logos with just their projects shown on the map, as shown in FIG. 23. The user is presented with a choice 212 of views for the map-based GUI, the choices being between Map/Terrain/Satellite/Earth. The default view is set by the NPO administrator via the central CMS 30. In FIG. 23 the default view is “earth”. All project data in the maps is the same as the view seen on an NPO homepage on the main NPO portal. Likewise, all content is controlled via the central CMS 30, accessed via a login on the website. As per the main website, when a user clicks on a project an information bubble opens (210, FIG. 24) giving options to donate or click for more information. FIG. 24 shows an example screen shot following a user selecting one of the flags displayed on the map. The user can browse projects in this manner and if they decide they want more information on a specific project they click on the link for ‘click here to see more’. A sub window 225 opens (not a separate window but the previous view moves to the background) which zooms the map into the chosen project, to a CMS controlled per project zoom level. An information window 230 has a number of information tabs. These give access to multimedia content stored in the CMS. FIG. 25 shows an example screen shot. If a user decides to donate at any stage a donate bubble appears replacing the tabs and the user can enter a donation amount at a CMS pre defined NPO, project, per line or unit per line level.

When a donation is made through the Facebook™ application a message is also posted to the user's newsfeed. This will display an entry of the type shown in FIG. 26, indicating which project the user donated to as well as a ‘Click to see project’ link. This will have the effect of encouraging other users of the social networking site to click and explore the project. Anyone clicking on this link will be brought to the donor2deed.com website where the map will zoom into the specified project and display the multimedia info tabs for that project. The fact that this news feed is seen by all of the ‘friends’ of the user contributes to the viral effect of other users checking out the application e.g. the first user ‘A’ donates to a project on the NPO's profile page and this fact appears on their news feed. A friend of user ‘A’ sees this fact and clicks on the link to see what project they donated to. If they donate, their separate network of friends see this and thus the viral donation effect of the Facebook™ network is employed. Project news updates can also be posted to a user's newsfeed, based on a user's preferences.

### Micro-Blogging Application

A Donor2Deed micro-blogging Application will be used to integrate a micro-blogging site, such as Twitter™ (http://www.twitter.com), with the Donor2Deed web site. Twitter™ will be used as a non-limiting example of a micro-blogging site.

Twitter™ is a free social networking and micro-blogging service that enables its users to send and read each others' updates, known as tweets. Tweets are text-based posts of up to 140 characters, displayed on the author's profile page and delivered to other users—known as followers—who have subscribed to them. Senders can restrict delivery to those in their circle of friends or, by default, allow open access. Users can send and receive tweets via the Twitter™ website, Short Message Service (SMS) or external applications. The service is free over the Internet, but using SMS may incur phone service provider fees.

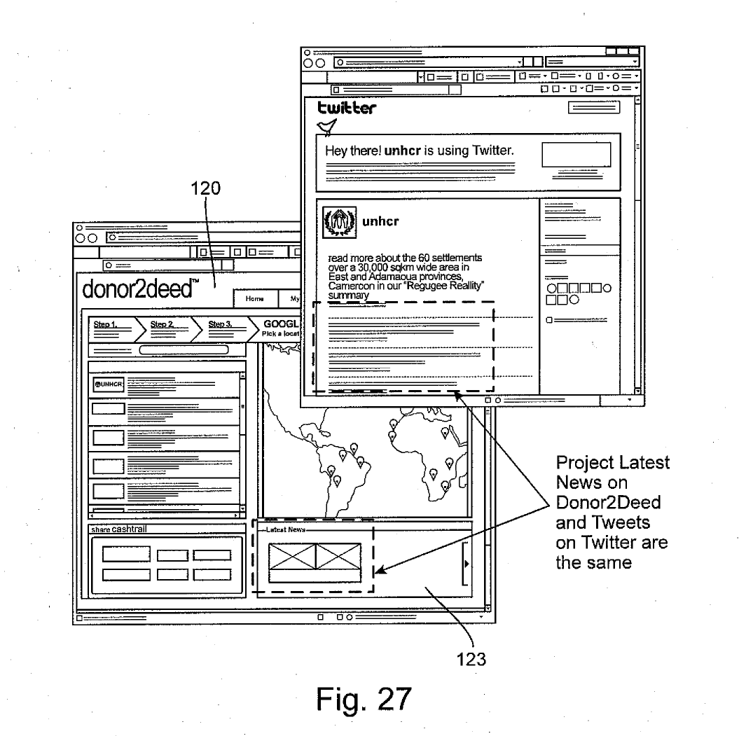

Each project hosted on Donor2Deed is required to setup a Twitter™ account if the project administrator wants to integrate Twitter™ with the Donor2Deed website. This Twitter™ account is dedicated to tweeting information regarding one specific project. The tweet content will have a one to one correspondence with the “Latest News” section of the Donor2Deed website. The “Latest News” for a project that appears on the Donor2Deed website will be the exact same as the tweet information for that project that appears on http://www.twitter.com. FIG. 27 shows an example screen shot.

There are 2 ways Donor2Deed and Twitter™ can exchange information:

1. Push information from Donor2Deed to Twitter™.

2. Pull information from Twitter™ to Donor2Deed.

Push from Donor2Deed to Twitter

When a project administrator enters a new “Latest News” item via the CMS tool on the Donor2Deed website, this information is automatically “pushed” to the project's twitter feed 56. Any “followers” of this feed will get the update from Twitter™ by the same means used by any normal Twitter™ feed.

As mentioned earlier, tweets are limited to 140 characters. Latest News on the Donor2Deed website can have a title of 200 characters and a description of 600 characters (a total of 800 characters per Latest News item). To circumvent this problem, any Latest News item updated using the Donor2Deed CMS tool will be truncated to 130 characters and will use the other 10 characters to encode a URL using URL tools tinyurl.com or bit.ly—both these are commonly used by Twitter™. This URL will link to the Latest News section on the Donor2Deed website for the specified project.

FIG. 27 shows that the latest news on the homepage 120 of the main site and the news feed pushed to Twitter™ are the same.

Pull from Twitter™ to Donor2Deed

A project administrator also has the option to enter the Latest News using Twitter™ (via the Twitter™ website, via SMS or any of the available methods of tweeting). In this case, Donor2Deed will periodically pull the latest tweets from Twitter™ via feed 52 and CMS Input Module 50 and store the tweets in the project database 32 associated with that project. The period at which Donor2Deed checks Twitter™ for new tweets is configurable but it is suggested that Donor2Deed checks every 30 minutes.

### Analytics and Statistics

User interaction with the web application 40 can be recorded and analyzed, recording such parameters as: number of hits; area of map viewed; what projects have been viewed and their locations; where the donor comes from and what they view e.g. US person views US projects.

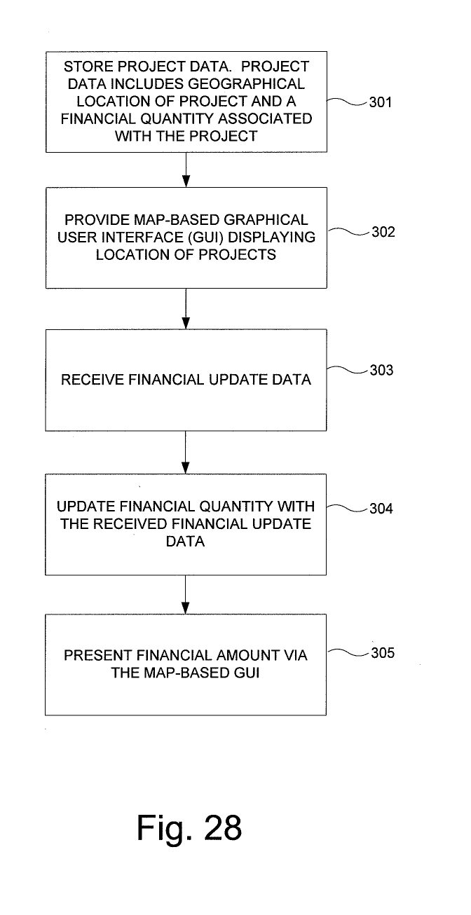

A reporting tool can forward financial information to database 32 when donated money has been spent in a project. In this way, the donor is able to view via the geo spatial maps, dynamically when the donation is spent. This adds transparency to the donation process. FIG. 28 shows a method of presenting financial information in a geo-spatial manner. At step 301 project data is stored (e.g. data 34, 35 stored in database 32). The project includes the geographical location of the project and a field which indicates a financial quantity associated with the project. Advantageously, this financial quantity is the amount spent. Other fields can indicate the amount raised, total amount required etc. At step 302 a map-based GUI is provided to display the locations of the projects. At step 303 financial update data is received. This update can be an update to the amount spent so far. The update data can be received from an external source, such as an accounting or reporting entity associated with the project. At step 304 the stored field is updated with the financial update data just received. At step 305 the amount spent is presented to a user via the map-based GUI. In this way, the financial data is dynamically updated. Steps 303-305 are repeated when a new update is received, so as to display up-to-date financial data. The financial quantity can be represented in one of the map views output by the map-based GUI. Depending on factors such as the scale of the map, the number of projects to display in the current view etc., the financial data can be represented by a numerical figure or by a graphical representation such as a barometer scale or traffic light (i.e. colors red, amber, green represent different ranges or percentages of funds). Other financial information can also be displayed in the map views, such as amount raised, amount required. The amount of money spent on a project can be displayed at various places within the information pages presented to a user. For example: the detailed project page shown in FIG. 13 can include an additional column which indicates amount spent to date. Similarly, frame 140 can include an additional field which indicates amount spent to date. Individual donors can also receive information about the funds spent, and the effects of their donation, via progress updates sent by the CMS via output modules 55. This aspect of the invention is not limited to donations to organizations, and can be applied more broadly to any application where it is useful to display or report financial data to a user. The term “financial data” includes any kind of financial or accounting data, such as financial analysis data and budget analysis data e.g. “budget vs. actual”.

### Accounting & Reporting

A report on the donation database 32 can show: the total donation, 3rd party charges, NPO id, project id, project section id, Donor2Deed cut, real donation etc. Another type of report can extract all donor details of a particular NPO. The addition of a DonorMappedID in the Donor database 32 can facilitate the possible mapping of donors to a different database (e.g. Kintera, Raisers Edge etc.)

Any of the functionality described here can be implemented in software, hardware or a combination of these. The functionality can be implemented by means of hardware comprising several distinct elements and by means of a suitably programmed processing apparatus. The processing apparatus can comprise a computer, a processor, a state machine, a logic array or any other suitable processing apparatus. The processing apparatus can be a general-purpose processor which executes software to cause the general-purpose processor to perform the required tasks, or the processing apparatus can be dedicated to the perform the required functions. Another aspect of the invention provides machine-readable instructions (software) which, when executed by a processor, perform any of the described methods. The machine-readable instructions may be stored on an electronic memory device, hard disk, optical disk or other machine-readable storage medium. The machine-readable instructions can be downloaded to a processing apparatus via a network connection.

Modifications and other embodiments of the disclosed invention will come to mind to one skilled in the art having the benefit of the teachings presented in the foregoing descriptions and the associated drawings. Therefore, it is to be understood that the invention is not to be limited to the specific embodiments disclosed and that modifications and other embodiments are intended to be included within the spirit and scope of this disclosure. Although specific terms may be employed herein, they are used in a generic and descriptive sense only and not for purposes of limitation.

What is claimed is:

1. A method of facilitating fundraising using a computer network comprising:
outputting, from a computer server, data identifying projects for which a user can make a donation, the data being presented using a map-based graphical user interface with a project identified on a map of a geographical area;
receiving, at the server, a user selection of at least one of the projects via the map-based graphical user interface.

2. A method according to claim 1 further comprising outputting, from the server, further details of the selected project.

3. A method according to claim 2 further comprising causing the map-based graphical user interface to present a larger scale map of the area where the selected project is located.

4. A method according to claim 1 further comprising outputting, from the server, a page on which a user can make a donation to a selected project.

5. A method according to claim 4 further comprising receiving, at the server, a user donation for the selected project.

6. A method according to claim 4 further comprising identifying, on the page, items within the selected project for which the user can make a donation.

7. A method according to claim 5 further comprising outputting a feed to at least one of: a social networking site and a micro-blogging site indicating that a donation has been made.

8. A method according to claim 7 wherein the feed comprises an identifier of the user who made the donation and an identifier of the project to which the donation was made.

9. A method according to claim 1 wherein the data identifying projects comprises information about projects of a plurality of different organizations, the projects of different organizations being presented together on the same map-based graphical user interface.

10. A method according to claim 9 wherein the data identifying projects comprises information about projects of a plurality of different organizations, the method further comprising:
outputting, from the server, a list of projects of different organizations;
receiving, at the server, a user selection of a project owned by a first one of the organizations; and
outputting only projects of the first organization on the map-based graphical user interface.

11. A method according to claim 1 further comprising receiving, at the server, progress information about progress of one of the projects.

12. A method according to claim 11 wherein the progress information is multimedia information.

13. A method according to claim 11 further comprising outputting, from the server, progress information about a project to a user who has made a donation to that project.

14. A method according to claim 11 further comprising:
storing details of a user who makes a donation;
receiving, progress information about progress of a project;
outputting the progress information to the user who made a donation.

15. A method according to claim 14 wherein the stored details comprise a preferred delivery mechanism for receiving progress information and the method further comprises outputting the progress information using the requested delivery mechanism.

16. A method according to claim 11 further comprising outputting progress information as a feed to a micro-blogging site.

17. A method according to claim 16 wherein the output feed to a micro-blogging site includes a compressed URL linking to a storage location of the progress information.

18. A method according to claim 1 further comprising receiving a position of a client device and wherein the step of outputting data outputs data about projects based on the position of the client device.

19. A machine-readable medium comprising instructions which, when executed by a processor, cause the processor to implement a method of facilitating fundraising using a computer network comprising:
outputting, from a computer server, data identifying projects for which a user can make a donation, the data being presented using a map-based graphical user interface with a project identified on a map of a geographical area;
receiving, at the server, a user selection of at least one of the projects via the map-based graphical user interface.

20. A computer server comprising:
a processor;
storage on which is stored instructions that are configured to cause the processor to:
output, from the computer server, data identifying projects for which a user can make a donation, the data being presented using a map-based graphical user interface with a project identified on a map of a geographical area;
receive, at the server, a user selection of at least one of the projects via the map-based graphical user interface.

21. A method of facilitating fundraising using a computer network comprising:
outputting, from a computer server, data identifying projects for which a user can make a donation;
receiving, at the server, a donation from a user for a selected one of the projects and storing details of the user;
receiving, at the server, progress information about progress of the selected project;
outputting the progress information to the user who made the donation using the stored details.

22. A method according to claim 21 wherein the stored details comprise a preferred delivery mechanism for receiving the progress information and the method further comprises outputting the progress information using the requested delivery mechanism.

23. A method of reporting financial data using a computer network;
storing, at a computer server, data for a plurality of projects, the project data including an identifier of the geographical location of the project and a first field representing a financial quantity associated with the project;
providing a map-based graphical user interface with the location of the projects identified on a map of a geographical area;
receiving financial update data;
updating the first field with the received financial update data;
presenting the first field via the map-based graphical user interface.

24. A method according to claim 23 wherein the first field is a financial quantity spent on the project and the financial update data is an update to the amount spent.
